(19) United States
(12) Patent Application Publication
(10) Pub. No.: US 2025/0285775 A1
(43) Pub. Date: Sep. 11, 2025

(54) MOLTEN SALT HEAT EXCHANGER

(71) Applicant: Board of Regents, The University of Texas System, Austin, TX (US)

(72) Inventor: Derek Haas, Austin, TX (US)

(21) Appl. No.: 19/064,193

(22) Filed: Feb. 26, 2025

Related U.S. Application Data
(60) Provisional application No. 63/561,853, filed on Mar. 6, 2024.

(51) Int. Cl. G21C 3/54; G21C 15/28; G21C 19/28

(52) U.S. Cl. CPC G21C 3/54; G21C 15/28; G21C 19/28

(57) ABSTRACT

A molten salt reactor system includes a fuel salt system and a coolant salt system. The fuel salt system is configured to circulate a molten fuel salt through a molten salt loop. The coolant salt system is configured to circulate a coolant salt through a coolant loop. The molten salt reactor system further includes a heat exchanger arranged along the molten salt loop and the coolant loop. The heat exchanger is configured to transfer heat from the molten fuel salt of the molten salt loop to the coolant salt of the coolant loop. The heat exchanger is configured to permit gravitational draining of at least one of the molten fuel salt or the coolant salt upon a shutdown event.

### RELATED APPLICATION

The present application relates and claims priority to U.S. Provisional Application No. 63/561,853, filed on Mar. 6, 2024, which is hereby incorporated by reference in its entirety.

### TECHNICAL FIELD

The described examples relate generally to systems, devices, and techniques for heat exchangers used in a molten salt system.

### BACKGROUND

Heat exchangers of various types are used in molten salt systems. A molten salt system may include a molten salt nuclear reactor system whereby a molten “fuel” salt is heated through nuclear fission reactions. One or more heat exchangers may be deployed in the molten salt system in order to transfer heat from the fuel salt to another medium, such as a coolant salt and/or other coolant medium. The molten fuel salt may include radioactive material, as may the coolant salt and/or other coolant medium. Such molten salt systems may operate continuously for prolonged periods, such as a period of years. Notwithstanding, the one or more heat exchangers deployed in the molten salt system may require maintenance, repair or replacement from time to time, and therefore, the molten salt system may be taken offline to facilitate such activity. Upon taking the molten salt system offline, however, the molten fuel salt and the coolant salt may begin to rapidly cool and solidify. Solidification of the molten fuel salt, coolant salt, and/or other materials in the heat exchanger could hinder the ability to maintain, repair, or replace said heat exchanger, particularly where the solidified materials include radioactive material. As such, there is a need for systems and techniques to facilitate the maintenance, repair, and replacement of heat exchangers in molten salt systems.

### SUMMARY

In one example, a molten salt reactor system is disclosed. The molten salt reactor system includes a fuel salt system configured to circulate a molten fuel salt through a molten salt loop. The molten salt system further includes a coolant salt system configured to circulate a coolant salt through a coolant loop. The molten salt system further includes a heat exchanger arranged along the molten salt loop and the coolant loop. The heat exchanger is configured to transfer heat from the molten fuel salt of the molten salt loop to the coolant salt of the coolant loop. The heat exchanger is configured to permit gravitational draining of at least one of the molten fuel salt or the coolant salt upon a shutdown event.

In another example, the heat exchanger may include an outer shell defining a shell volume configured to receive one of the molten fuel salt or the coolant salt. The heat exchanger may further include an internal tube positioned at least partially within the shell volume and configured to receive the other of the molten fuel salt or the coolant salt.

In another example, the outer shell may include a baffle defining a shell circulation path about a portion of the internal tube positioned in the shell volume. In this regard, the heat exchanger may be arranged on the molten salt loop and the coolant loop with the circulation path positioned off-set from a horizontal direction of the molten salt reactor system.

In another example, the internal tube may extend oblique to the outer shell within the shell volume.

In another example, the internal tube may include a plurality of bends within the internal tube volume. In this regard, the oblique orientation of the internal tube relative to the outer shell may permit draining of the other of the molten fuel salt or the coolant salt upon the shutdown event.

In another example, the internal tube may extend substantially along the shell circulation path.

In another example, the shell circulation path may proceed along a U-shaped path through the shell volume. The internal tube may include a U-shaped tube extending along the U-shaped path. Further, an inlet and an outlet for the shell circulation path and an inlet and outlet for the internal tube may each be arranged along a bottom side of the outer shell such that the respective inlets and outlets are each substantially aligned with a vertical direction of the molten salt reactor system.

In another example, the shutdown event may be triggered based on one or more of a loss of power, a high radiation alarm and/or a containment breach.

In another example, the molten salt reactor system may include a reactor vessel, a pump, and a drain tank all arranged along the molten salt loop. Further, the reactor vessel may output an elevated temperature form of the molten salt to the heat exchanger.

In another example, the heat exchanger may include a pair of oblique tubes associated with one another inside of an outer shell. A first oblique tube of the pair of oblique tubes may be configured to receive one of the molten fuel salt or the coolant salt. A second oblique tube of the pair of oblique tubes may be configured to receive the other of the molten fuel salt or the coolant salt.

In another example, the first oblique tube may be removably couplable from the outer shell and separatable from the first oblique tube.

In yet another example, the molten salt reactor system further includes a flange assembly operable to facilitate removal of the heat exchanger from the molten salt reactor system.

In another example, a molten salt reactor system is disclosed. The system includes a fuel salt system configured to circulate a molten fuel salt through a molten salt loop. The system further includes a coolant salt system configured to circulate a coolant salt through a coolant loop. The system further includes a heat exchanger arranged along the molten salt loop and the coolant loop and configured to transfer heat from the molten fuel salt of the molten salt loop to the coolant salt of the coolant loop. The heat exchanger includes at least one oblique tube configured to route at least one of the molten fuel salt or the coolant salt out of the heat exchanger upon a shutdown event.

In another example, the heat exchanger may include a shell and tube heat exchanger. Further, the at least one oblique tube may be arranged oblique to an outer shell of the shell and tube heat exchanger.

In another example, the molten fuel salt and the coolant salt may begin to solidify at a solidification temperature that is below 550° C.

In another example, the at least one oblique tube may include a first oblique tube configured to route the molten fuel salt out of the heat exchanger, and a second oblique tube configured to route the coolant salt out of the heat exchanger.

In another example, a portion of the first oblique tube and a corresponding portion of the second oblique tube may be removably interposed with one another with an outer shell of the heat exchanger.

In yet another example, the molten salt reactor system further includes a flange assembly operable to facilitate removal of the heat exchanger from the molten salt reactor system.

In another example, a method of draining a heat exchanger of a molten salt reactor system is disclosed. The method includes operating a fuel salt system by circulating a molten fuel salt through a molten salt loop. The method further includes operating a coolant salt system by circulating a coolant salt through a coolant salt loop. The method further includes transferring heat, using a heat exchanger, from the molten fuel salt of the molten salt loop to the coolant salt of the coolant salt loop. The method further includes gravitationally draining, upon a shutdown event, the molten fuel salt and the coolant salt from the heat exchanger.

In another example, the heat exchanger may include at least one oblique tube configured to route at least one of the molten fuel salt or the coolant salt through the heat exchanger during the transferring.

In another example, said at least oblique tube may be arranged oblique to an outer shell of the heat exchanger.

In another example, the molten fuel salt may include a fissile material.

In addition to the example aspects described above, further aspects and examples will become apparent by reference to the drawings and by study of the following description.

### BRIEF DESCRIPTION OF THE DRAWINGS

FIG. 1 depicts an example molten salt reactor system.

FIG. 2A depicts an example heat exchanger of the molten salt reactor system of FIG. 1.

FIG. 2B depicts a cross-sectional view of the heat exchanger of FIG. 2A, taken along line 2B-2B of FIG. 2A.

FIG. 3A depicts another example heat exchanger.

FIG. 3B depicts a cross-sectional view of the heat exchanger of FIG. 3A, taken along lines 3B-3B of FIG. 3A.

FIG. 4A depicts another example heat exchanger.

FIG. 4B depicts a cutaway view of the heat exchanger of FIG. 4A.

FIG. 5A depicts another example heat exchanger.

FIG. 5B depicts a cross-sectional view of the heat exchanger of FIG. 5A, take along line 5B-5B of FIG. 5A.

FIG. 5C depicts an exploded view of the heat exchanger of FIG. 5A.

FIG. 6A depicts an example installation of an example heat exchanger in a molten salt reactor system.

FIG. 6B depicts another view of the example installation of FIG. 6A.

FIG. 7 depicts a flow diagram of a method of draining a heat exchanger of a molten salt reactor system.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

The description that follows includes sample systems, methods, and apparatuses that embody various elements of the present disclosure. However, it should be understood that the described disclosure may be practiced in a variety of forms in addition to those described herein.

The following disclosure relates generally to heat exchangers for a molten salt system. A molten salt system may include a molten salt nuclear reactor system whereby a molten “fuel” salt is heated through nuclear fission reactions. One or more heat exchangers may be deployed in the molten salt system in order to transfer heat from the fuel salt to another medium, such as a coolant salt or other coolant medium. The molten fuel salt may include radioactive material, as may the coolant salt or other coolant medium. Such molten salt systems may operate continuously for prolonged periods, such as a period of years. Notwithstanding, the one or more heat exchangers deployed in the molten salt system may require maintenance, repair or replacement from time to time, and therefore, the molten salt system may be taken offline to facilitate such activity. Upon taking the molten salt system offline, however, the molten fuel salt and the coolant salt may begin to rapidly cool and solidify. Solidification of the molten fuel salt, coolant salt, and/or other materials in the heat exchanger could hinder the ability to maintain, repair, or replace said heat exchanger, particularly where the solidified materials include radioactive material. Conventional heat exchangers may implement heat exchangers whereby the molten salt materials and/or other materials are susceptible to solidifying in the heat exchanger or otherwise to causing the heat exchanger to be inoperable and/or irreparable on shutdown of the molten salt system.

To mitigate these and other challenges, a molten salt system is disclosed herein with a heat exchanger that permits draining of materials (e.g., fuel salt, coolant salt, and/or other materials) on shutdown (e.g., a shutdown event) of the molten salt system. As used herein, a “shutdown event” may include any event in which the molten salt system ceases to circulate molten salt and/or otherwise ceases to produce nuclear reactions therefrom or therewith, including planned and unplanned shutdowns of the molten salt system. For example, the heat exchangers disclosed herein may include at least one oblique tube that is configured to route at least one of a molten fuel salt or a coolant salt out of the heat exchanger upon a shut down event of the molten salt system. The oblique tube may be oblique to a horizontal axis of the heat exchanger, which may thereby encourage any materials held therein to drain from the heat exchanger upon such shutdown event. As the fuel salt, coolant salt and/or other materials may be readily drained from the heat exchanger, the heat exchanger may be clear or substantially clear of (or have a reduced amount of) radioactive material therein upon the shutdown event. Accordingly, the reduced level of radioactive material in the heat exchanger upon the shutdown event may support the maintenance, repair, and replacement of the heat exchanger, in part, by reducing the risk of handling the heat exchanger due to said reduced level of radioactive material therein. Additionally, the heat exchanger may be installed within the molten salt system such that it can be removed without requiring substantial dismantling of said system.

To facilitate the foregoing, the heat exchangers of the present disclosure may be a shell and tube type heat exchanger. The shell and tube type heat exchanger may, in one example, include an outer shell and an inner tube arranged within the shell. The outer shell may be configured to circulate a first medium therethrough, such as a fuel salt. The inner tube may be configured to circulate second medium therethrough, such as a coolant salt. The inner tube may be positioned within the outer shell such that the fuel salt (or other medium) bathes the inner tube with the fuel salt, and thereby promotes the transfer of heat from the fuel salt to the coolant salt held in the inner tube. In one example, the shell and tube type heat exchanger may be configured to permit gravitational draining of the fuel salt and coolant salt therein. For example, the inlet and outlet of the outer shell may be arranged oblique to or otherwise offset from a horizontal axis of the heat exchanger. In this regard, upon the occurrence of a shutdown event, fluid (e.g., a molten fuel salt) held therein may be encouraged to drain from the outer shell, as opposed to otherwise solidifying within the outer shell. As a further example, the inlet and outlet of the inner tube may additionally or alternatively be arranged offset from a horizontal axis of the heat exchanger. In this regard, upon the occurrence of a shutdown event, fluid (e.g., a molten fuel salt) held therein may be encouraged to drain from the inner tube, as opposed to otherwise solidifying within the inner tube. In some cases, the respective inlet and outlet of the outer shell and inner tube may be arranged along a common direction to facilitate draining of the fluids contained therein along said common direction. Further, in some cases, one or both of the respective inlets and outlets of the shell and tube may be arranged substantially along a vertical axis of the heat exchanger, which may facilitate draining of fluids (molten salts) contained therein along said vertical axis upon a shutdown event.

In one example, the heat exchangers of the present disclosure may be installed into a molten salt system such that they can be removed for maintenance following drainage of the coolant medium therein. In this regard, the heat exchanger can be removed without requiring substantial dismantling of the molten salt system. For example, the heat exchanger may be installed via a flange assembly penetrating the reactor enclosure.

In another example, the heat exchangers disclosed herein may include one or more features to facilitate the containment of fluids held therein, such as the containment of any leak of a radioactive material from said fluids. For example, the heat exchangers of the present disclosure may include an outer shell, and a first inner tube and a second inner tube each held within the outer shell. The first inner tube may be configured to carry a first fluid (e.g., a molten fuel salt) and the second inner tube may be configured to carry a second fluid (e.g., a coolant salt). The first inner tube and the second inner tube may be arranged relative to one another in order to facilitate the transfer of heat between, for example, the fuel salt of the first inner tube to the coolant salt of the second inner tube. The outer shell may be fitted around the first inner tube and the second inner tube, such as being fitting around a portion of the first inner tube and a corresponding portion of the second inner tube that is configured to transfer heat therebetween, and serve as a containment structure in the event of a leaks from either tube. Further, in such arrangement, neither the first nor the second inner tube may be bathed, externally in a corrosive fluid. Accordingly, the inner tubes, and heat exchanger more generally, may exhibit enhance resistance to corrosive materials, which may prolong the service life of the heat exchanger. In some cases, one or both of the first inner tube and/or the second inner tube may be selectively removable from the outer tube, as described herein. In this regard, the respective inner tubes may be replaceable components of the heat exchanger, and may therefore allow the heat exchanger to be maintained and repaired during a shutdown event without necessarily requiring the entire heat exchanger to be removed from the molten salt system.

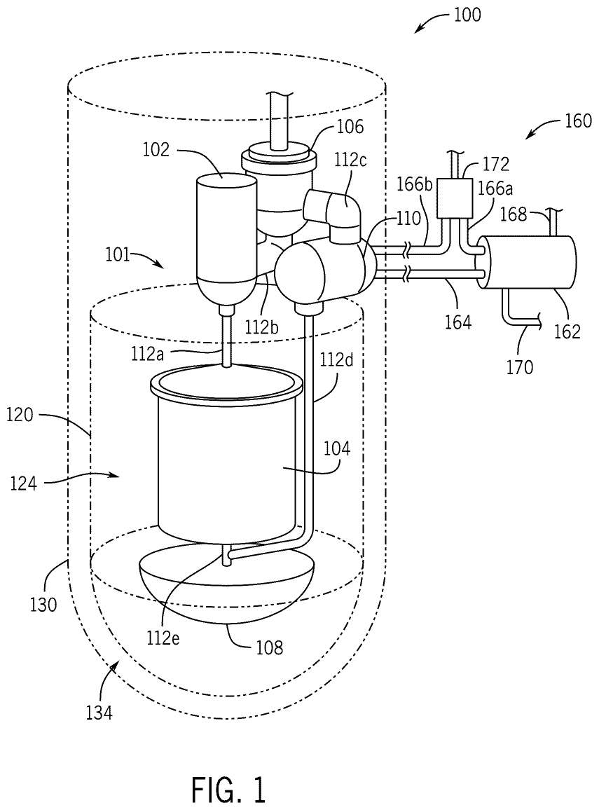

Turning to the Drawings, FIG. 1 depicts an example molten salt reactor system 100. The molten salt reactor system 100 is depicted and described herein to illustrate example process equipment with which the various heat exchangers and associated apparatuses and systems of the present disclosure may be used. Accordingly, while the molten salt reactor system 100 is described herein, it will be appreciated that such heat exchangers and associated apparatuses and systems may be used with a variety of process equipment to detect leaks of conducting fluid being carried therethrough, as described herein.

With reference to the molten salt reactor system 100 of FIG. 1, the example molten salt reactor system 100 of FIG. 1 utilizes fuel salt enriched with uranium (e.g., high-assay low-enriched uranium) to create thermal power via nuclear fission reactions. In at least one example, the composition of the fuel salt may be LiF—BeF₂—UF₄, though other compositions of fuel salts may be utilized as fuel salts within the reactor system 100. The fuel salt within the system 100 is heated to high temperatures (such as 600° C. or greater) and melts as the system 100 is heated.

As shown in FIG. 1, the molten salt reactor system 100 includes a reactor vessel 104 where the nuclear reactions occur within the molten fuel salt, a fuel salt pump 106 that pumps the molten fuel salt to a heat exchanger 110, such that the molten fuel salt re-enters the reactor vessel after flowing through the heat exchanger 110, and piping in between each component (e.g., piping 112a, 112b, 112c, 112d, 112e). The molten salt reactor system 100 may also include additional components, such as, but not limited to, drain tank 108 and reactor access vessel 102. The drain tank 108 may be configured to store the fuel salt once the fuel salt is in the reactor system 100 but in a subcritical state, and also acts as storage for the fuel salt if power is lost in the system 100. The reactor access vessel 102 may be configured to allow for introduction of small pellets of uranium fluoride (UF₄) to the system 100 as necessary to bring the reactor to a critical state and compensate for depletion of fissile material. In several examples, the molten salt reactor system 100 may include an inert gas system and/or an equalization system (not shown in FIG. 1) to provide inert gas to a head space of the various salt-bearing components of the system 100 and to equalize pressures therebetween as needed for a given operation of the system 100.

FIG. 1 further shows the system 100 as including an internal vessel or shield 120 that defines a first thermally insulative region 124 about select components of the system 100. FIG. 1 further shows the system 100 as including a reactor enclosure 130. The reactor enclosure 130 may be constructed from a thermally insulative metal (including certain stainless steels) that is capable of withstanding substantially high temperatures, such as temperature in excess of 600° C. The reactor enclosure 130 is shown, schematically, as encompassing the entirety of the internal shield 120 and any other salt-bearing components that are not otherwise included with the internal shield 120. For example, the reactor enclosure 130 may define a second thermally insulative region 134 that receives the internal shield 120 and all the salt-bearing components that are not held within the first thermally insulative region 124. The internal shield 120 and the reactor enclosure 130 may therefore each define a containment barrier about the salt-bearing components of the system 100. Further, the internal shield 120 and the reactor enclosure 130 may define a substantially high-radiation and high-temperature zone of the system 100.

The system 100, as described herein, may be configured to generate heat energy via nuclear fission reactions with the molten fuel salt that is circulated through, among other components, the reactor vessel 104. For example, the molten fuel salt may circulate through a fuel salt system 101 or “loop” including the reactor vessel 104, the primary access vessel 102, the pump 106, and the heat exchanger 110. Broadly, the molten fuel salt may exhibit an elevated temperature at an exit of the reactor vessel 104 as a result of fission reactions occurring therein. Such elevated temperature molten fuel salt may circulate through the fuel salt system 101 until the salt reaches the heat exchanger 110. At the heat exchanger 110, said heat may be extracted from the fuel salt. In turn, the lower temperature molten fuel salt may continue to circulate through the fuel salt system 101 until it reaches the entrance to the reactor vessel 104, within which the salt may again increase in temperature via nuclear fission reactions.

The heat may be extracted from the fuel salt at the heat exchanger 110, in part, using a coolant salt system 160. The coolant salt system 160 may circulate a coolant salt through the heat exchanger 110 (also referred to herein as a “primary” heat exchanger). For example, and as shown in FIG. 1, the coolant salt system 160 may include a secondary heat exchanger 162 and a coolant pump 172. The secondary heat exchanger 162 may be any appropriate heat exchanger, such as a shell and tube type heat exchanger, and be configured to circulate a coolant salt with the primary heat exchanger 110 via a flow induce by the coolant pump 172. For example, and as shown in FIG. 1, the coolant salt system 160 may include a primary coolant loop cold legs 166a, 166b whereby a lower-temperature coolant is induced toward and into the primary heat exchanger 110 via the coolant pump 172. The lower temperature coolant may receive heat from the high temperature fuel salt within the primary heat exchanger 110. In turn, the coolant salt may exit the primary heat exchanger 110 having an elevated temperature, and may proceed to the secondary heat exchanger 162 via the secondary coolant loop hot leg 168. The secondary heat exchanger 162 may, in turn, operate to extract heat from the primary coolant, and transfer said heat to another medium, such that the heat may be used to drive one or more processes (e.g., electrical power generation, chemical processing, and so on). For example, and as shown in FIG. 1, the secondary heat exchanger 162 may be fluidically coupled with a secondary coolant loop cold leg 170 whereat a lower temperature coolant medium may enter the secondary heat exchanger 162. As further shown in FIG. 1, the secondary heat exchanger 162 may be fluidically coupled with a secondary coolant loop hot leg 168 whereat a higher temperature coolant medium may exit the secondary heat exchanger 162 after receiving heat from the primary coolant within the secondary heat exchanger 162.

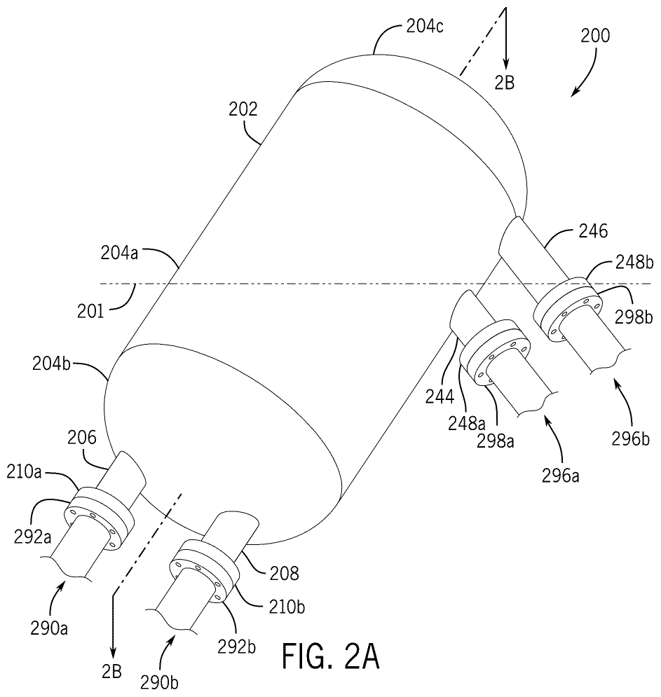

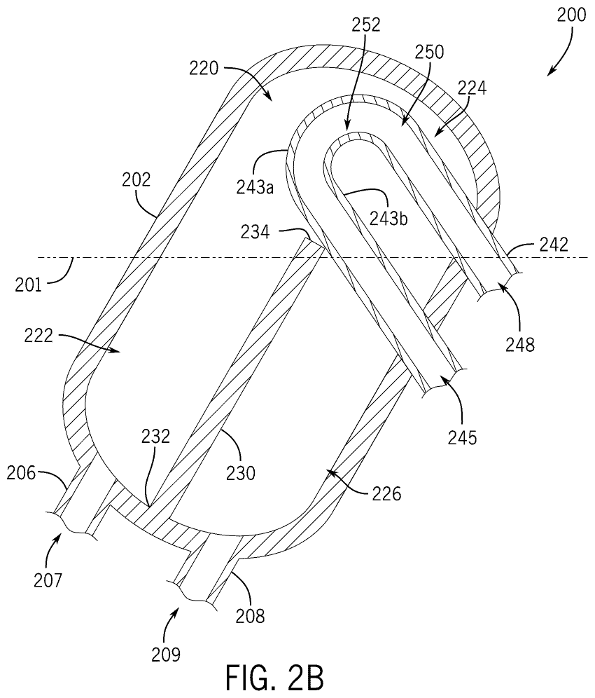

The primary heat exchanger 110, the secondary heat exchanger 162 and/or any other heat exchangers included with or associated with the molten salt system 100 may be configured as a heat exchanger of the present disclosure. For example, the primary heat exchanger 110, the secondary heat exchanger 162 and/or other heat exchangers may be configured to permit gravitational draining of one or more fluids of salt therein, including the gravitational draining of at least one of a molten fuel salt or coolant salt held therein. In this regard, the primary heat exchanger 110, the secondary heat exchanger 162, and/or any other heat exchanger may be configured in a manner to support the exit of potentially radioactive materials therefrom upon a shutdown event, and thereby support the maintenance, repair and replacement of said heat exchangers and other components of the molten salt system. In this regard, it will be appreciated that the primary heat exchanger 110, the second heat exchanger 162 and/or any other heat exchangers of the molten salt system may take the form of the various heat exchangers described in turn below in relation to FIGS. 2A-5C and/or may take the form of other variations of heat exchangers whereby said heat exchanger is configured to permit gravitational draining upon a shutdown event. In this regard, while examples of such heat exchangers are described in turn below in relation to FIGS. 2A-5C, it will be appreciated that in other examples, other arrangements and configured of heat exchangers that permit gravitational draining of molten fuel salt and/or coolant salt are possible and contemplated herein.

With reference to FIGS. 2A and 2B, an example heat exchange 200 is shown. The example heat exchanger 200 may be used in the molten salt system 100 as the primary heat exchanger 110, the secondary heat exchanger 162, and/or other heat exchanger of the system 100. The heat exchanger 200 is shown in FIG. 2B in cross-section, taken along line 2B-2B of FIG. 2A. The heat exchanger 200 is shown in FIGS. 2A and 2B relative to a horizontal axis 201. The horizontal axis 201 may be perpendicular to a gravitational direction of the heat exchanger 200. The heat exchanger 200 may therefore be configured to permit gravitational draining of fluids (e.g., molten salts therein) by arranging one or more inlets or outlets thereof offset or oblique from the horizontal axis 201.

The heat exchanger 200 may generally be constructed as a shell and tube type heat exchanger having an outer shell 202 and an inner tube 242 passing therein. The outer shell 202 may be configured as a pressure vessel configured to withstand temperatures in excess of 600° C. and pressures sufficiently above atmospheric. The outer shell 202 may be constructed from certain metal materials, including stainless steel and/or other corrosivity resistant materials. The outer shell 202 is shown in FIG. 2B as including a cylindrical region 204a, and end cap regions 204b, 204c. The end cap regions 204b, 204c may each be connected (e.g., welded) to opposing ends of the cylindrical region 204a in order to form the shell volume 220 therein. The shell volume 220 may be configured to circulate a fluid therethrough for heat transfer to a fluid of the inner tube 242. In this regard, and as shown in further detail in FIG. 2B, the outer shell 202 may include a shell inlet 206 having an inlet passage 207 therethrough and a shell outlet 208 having an outlet passage 209 therethrough. The inlet passage 207 may extend through the shell inlet 206 to provide a fluid passage between a portion of the shell volume 220 and an environment external thereto (such as associated process piping). Further, the outlet passage 209 may extend through the shell outlet 208 to provide a fluid passage between a portion of the shell volume 220 and an environment external thereto (such as associated process piping). The outer shell 202 is further shown in FIG. 2B as including a baffle structure 230 held therein. The baffle structure 230 may include one or more elongated structures extending from an internal wall of the outer shell 202 in order to define a flow path through the shell volume 220. For example, the baffle structure 230 may include a partition wall or other obstructing feature that extends from a baffle first end 232 attached to said inner wall, to a baffle second end 234 that may be a free end arranged within the shell volume 220. In some cases, as described herein, the baffle second end 234 may be used to structurally support or otherwise engage with a portion of the inner tube 242. The arrangement of the baffle 230 shown in FIG. 2B defines a flow or circulation path through the shell volume 220 between the shell inlet 206 and the shell outlet 208. For example, the baffle 230 may define a hot region 222 proximal the shell inlet 206 (where the outer shell 220 is used to receive elevated temperature fluid), a heat transfer region 224 proximal the baffle end 234, and a cold region 226 proximal the shell outlet 208. In this regard, fluid may flow along the circulation path from the hot region 222, to the heat transfer region 224, and to the cold region 226 with the shell volume 220 of the outer shell 202. It will be appreciated that where the outer shell 220 is used to receive lower temperature fluid the region 222 may be “hot” and the region 226 may be “cold”.

To facilitate the temperature change of the fluid between the hot region 222 and the cold region 226, the inner tube 242 may be arranged substantially within the heat transfer region 224 of the shell volume 220. The inner tube 242 is shown in FIG. 2B as proceeding through a thickness of a wall of the outer shell 2202 and extending through the shell volume 220 along a U-shaped path generally oblique to the horizontal axis 201. In other cases, the inner tube 242 may have a plurality of bends within the shell volume 220. The inner tube 242 may therefore define a tube inlet 244 having an inlet passage 245 extending therethrough and a tube outlet 246 having a outlet passage 247 extending therethrough. The tube inlet 244 may be a structural portion of the inner tube 242 that extends through a wall of the outer shell 202 such that the inlet passage 245 fluidically couples a tube volume 250 with an environment external thereto (such as associated process piping). Further, the tube outlet 246 may be a structural portion of the outer tube 242 that extends through a wall of the outer shell 202 such that outlet passage 247 fluidically couples the tube volume 250 with an environment external thereto (such as associated process piping). In this regard, fluid (e.g., a molten salt) may be circulated through the tube volume and be exposed to heat with the heat transfer region 224 of the shell volume 220. For example, fluid contained in the heat transfer region 224 may bathe all or substantially all of the inner tube 242 that is held within the heat transfer region 224, such as bathing first and second surfaces 243a, 243b of the inner tube 242. The bathing of such surfaces may permit the transfer of heat from the hotter of the fluids to the cooler of the fluids substantially within the heat transfer region 224.

The heat exchanger 200 may be coupled within the molten salt system (e.g., such as the system 200) via various flanged connections, such as those shown in FIG. 2A. For example, the shell inlet 206 and the shell outlet 208 may include flanged connections 210a, 210b, respectively. The flanged connections 210a, 201b may be configured for fluidic coupling with corresponding flanged connections 292a, 292b of fuel salt piping 290a, 290b and/or other service piping based on a configuration of the heat exchanger 200 within the molten salt system. Additionally, as shown FIG. 2A, the tube inlet 244 and the tube outlet 246 may include flanged connections 248a, 248b respectively. The flanged connections 248a, 248b may be configured for fluidic coupling with corresponding flanged connections 298a, 298b of coolant salt piping 296a, 296b and/or other service piping based on a configuration of the heat exchanger 200 within the molten salt system 200.

As shown in FIGS. 2A and 2B, the heat exchanger 200 may be configured to permit gravitational draining of at least one of a molten fuel salt or a coolant salt upon a shutdown event. For example, each of shell inlet 206 and shell outlet 208 are shown arranged oblique to the horizontal axis 201. In this regard, fluid held within the shell volume 220 may be encouraged to exit the shell volume 220 via gravitational flow from the shell volume 220 and through the inlet passage 207 and outlet passage 209. Further, each of the tube inlet 244 and the tube outlet 246 are shown arranged oblique to the horizontal axis 201. In this regard, fluid held within the tube volume 250 may be encouraged to exit the tube volume 250 via gravitational flow from the tube volume 250 and through the inlet passage 245 and outlet passage 248. Accordingly, to the extent that either shell volume 220 or the tube volume 250 includes molten materials, rather than solidify therein upon a shutdown event, said molten materials may be encouraged to gravitationally exit said volumes. Because the molten materials may exit the respective volumes, the heat exchanger 200 may support the maintenance, repair, and replacement thereof because the heat exchanger 200 may have a reduce amount of solidified radioactive material held therein.

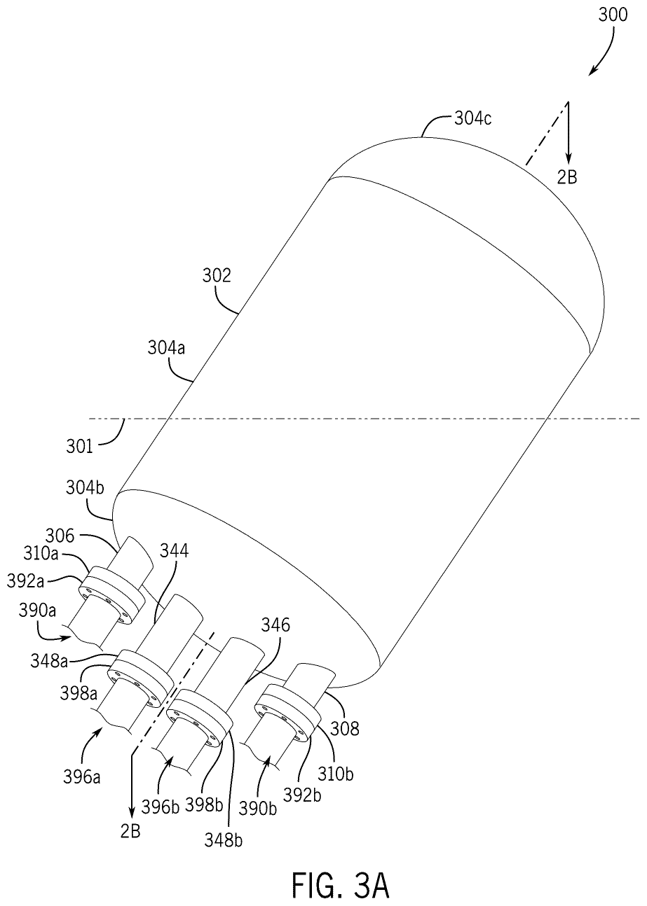

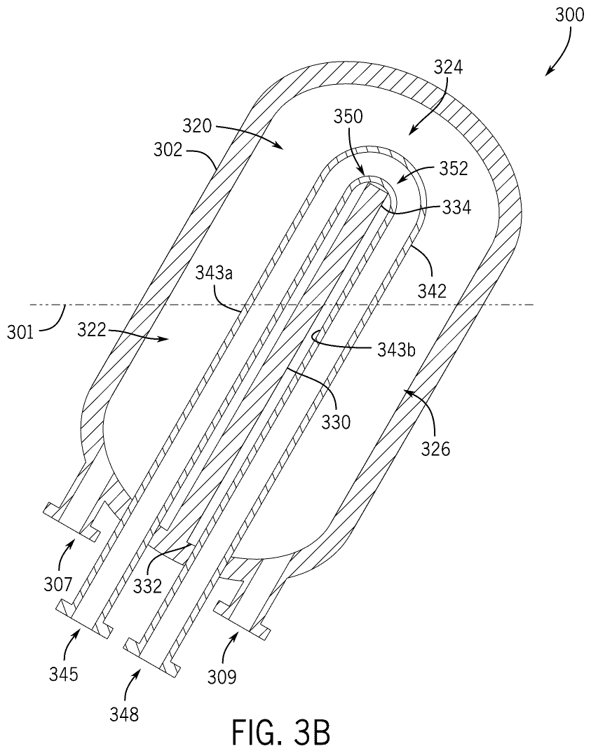

With reference to FIG. 3A and 3B, an example heat exchanger 300 is shown. The example heat exchanger 300 may be used in the molten salt system 100 as the primary heat exchanger 110, the second heat exchanger 162, and/or other heat exchanger of the system 100. The heat exchanger 300 is shown in FIG. 3B in cross-section, taken along line 3B-3B of FIG. 3A. The heat exchanger 300 is shown in FIGS. 3A and 3B relative to a horizontal axis 301. The horizontal axis 301 may be perpendicular to a gravitational direction of the heat exchanger 300. The heat exchanger 300 may therefore be configured to permit gravitation draining of fluids (e.g., molten salts therein) by arranging one or more inlets or outlets thereof offset or oblique from the horizontal axis 301. It will be appreciated that in some cases, the one or more inlets or outlets thereof may be arranged perpendicular from the horizontal axis 301 such that the respective inlets and outlets are generally arranged along a vertical axis of the heat exchanger 300 to support gravitational draining therealong. In this regard, the heat exchanger 300 may be substantially analogous to the heat exchanger 200 may include: an outer shell 302, a cylindrical region 304a, end cap regions 304b, 304c, a shell inlet 206, an inlet passage 207, flanged connections 310a, 310b, a shell volume 320, a cold region 322, a heat transfer region 324, a hot region 326, a baffle structure 330, a first baffle end 332, a second baffle end 334, an inner tube 342, a first surface 343a, a second surface 343b, a tube inlet 344, an inlet passage 345, a tube outlet 346, an outlet passage 347, flanged connections 348a, 348b, a tube volume 350, a heat transfer region 352, fuel salt piping 390a, 390b, flanged connections 392a, 392b, coolant salt piping 396a, 396b, and flanged connections 398a, 398b; redundant explanation of which is omitted here for clarity.

Notwithstanding the foregoing similarities, the shell inlet 306 and the shell outlet 308 are shown arranged along a common direction as the tube inlet 344 and the tube outlet 346. In this regard, both the shell volume 320 and the tube volume 350 may be configured to gravitationally drain along the same direction. In FIGS. 3A and 3B, the respective inlets and outlets are shown oblique to the horizontal axis 301; in other cases, such inlets and outlets may be arranged perpendicular to the horizontal axis 301 such that the inlets and outlets are each substantially aligned with a vertical axis of the heat exchanger 300. In turn, the heat exchanger 300 may facilitate maintenance, repair and replacement thereof as said fluids (e.g., molten salts) drain along a common direction, and as such, the heat exchanger 300 may be more readily uncoupled from the molten salt system. To facilitate the arrangement of the shell inlet 306, the shell outlet 308, the tube inlet 344 and the tube outlet 346 as being arranged along a common direction, the inner tube 342 may extend through the shell volume 320 along a U-shaped path about and over the baffle structure 330, as shown in FIG. 3B. Such configuration may allow the fluid held within the shell volume 320 to bathe a greater surface area of the inner tube 342, and thereby promote the efficient heat transfer between the two fluids of the respective volumes.

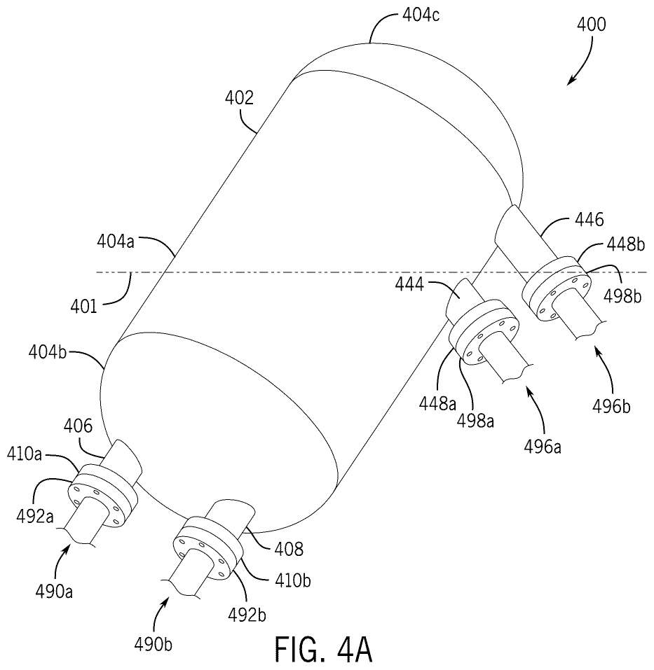

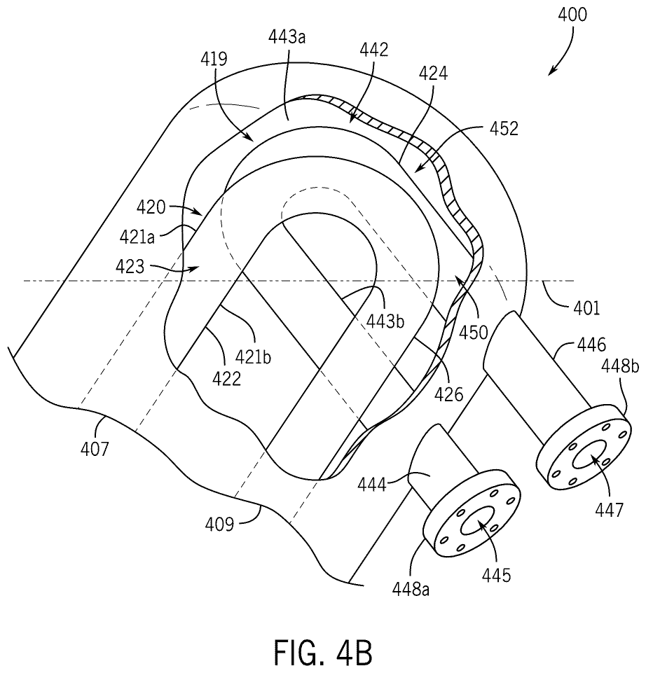

With reference to FIGS. 4A and 4B, an example heat exchanger 400 is shown. The example heat exchanger 400 may be used in the molten salt system 100 as the primary heat exchanger 110, the secondary heat exchanger 162, and/or other heat exchanger of the system 100. The heat exchanger 400 is shown in FIG. 4B in a cutaway view of the heat exchanger of FIG. 4A. The heat exchanger 400 is shown in FIGS. 4A and 4B relative to a horizontal axis 401. The horizontal axis 401 may be perpendicular to a gravitational direction of the heat exchanger 400. The heat exchanger 400 may therefore be configured to permit gravitational draining of fluids (e.g., molten salts therein) by arranging one or more inlets or outlets thereof offset or oblique from the horizontal axis 401. In this regard, the heat exchanger 400 may be substantially analogous to the heat exchanger 200, and may include: an outer shell 402, a cylindrical region 404a, end cap regions 404b, 404c, flanged connections 410a, 410b, an inner tube 442, a first surface 443a, a second surface 443b, a tube inlet 444, an inlet passage 445, a tube outlet 446, an outlet passage 447, flanged connections 448a, 448b, tube volume 450, a heat transfer region 452, fuel salt piping 490a, 490b, flanged connections 492a, 492b, coolant salt piping 496a, 496b, and flanged connections 498a, 498b; redundant explanation of which is omitted here for clarity.

Notwithstanding the foregoing similarities, the heat exchanger 400 is arranged with a shell tube 420 to carry the molten fuel salt (or other fluid) through the outer shell 402. In this regard, the outer shell 402 may operate as a containment structure defining a containment volume 419 within which a portion of the shell tube 420 and the inner tube 442 are arranged. For example, the shell tube 420 may define a U-shaped tube extending through the containment volume between a shell tube inlet 406 and a shell tube outlet 408. In the regard, the shell tube 420 may have a volume 423 which extends between an inlet passage 407 and an outlet passage 409 and which is fluidically separated from the containment volume 419. In this regard, fluid may progress through the volume 423 and not within the containment volume 419 so as to not bathe the inner tube 442. Notwithstanding, the shell tube 420 may generally define a hot region 422, a heat transfer region 424, and a cold region 426. Fluid (such as a heated molten salt) may therefore proceed into the heat exchanger 400 via the inlet passage 407 and along the hot region 422. At the heat transfer region 424, the inner tube 442 (which may carry a relatively cooler coolant salt) may be arranged such that the heat may transfer from the fluid of the shell tube 420 to the fluid of inner tube 442. In some cases, surfaces 421a, 421b of the shell tube 420 maybe in contact with surfaces 443a, 443b to facilitate the foregoing. The fluid of the shell tube 420 may be subsequently exit the volume 423 via the outlet passage 409 of the shell tube outlet 408.

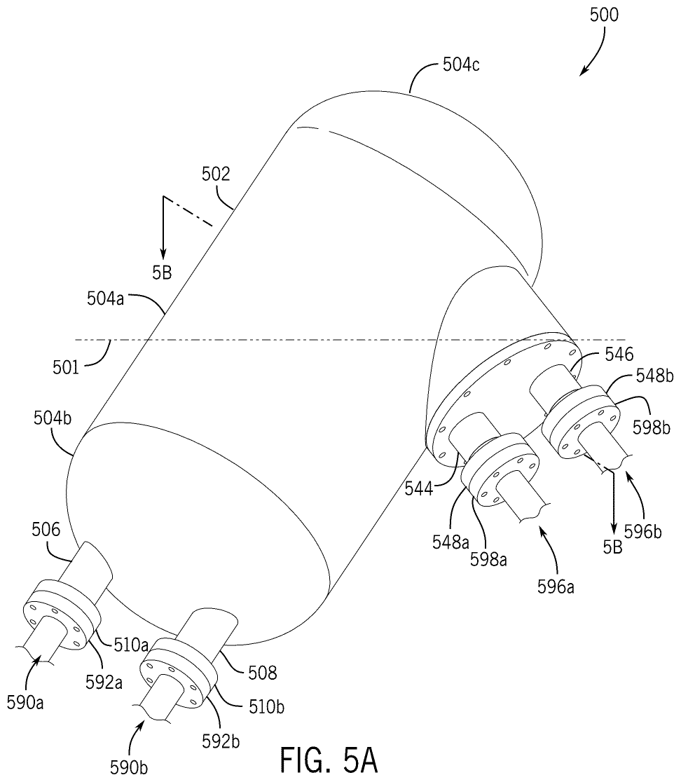

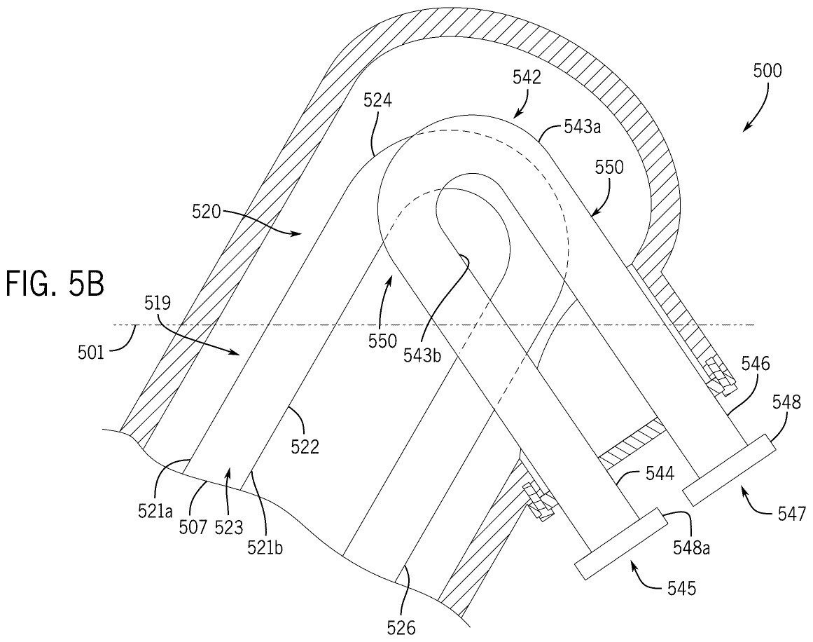

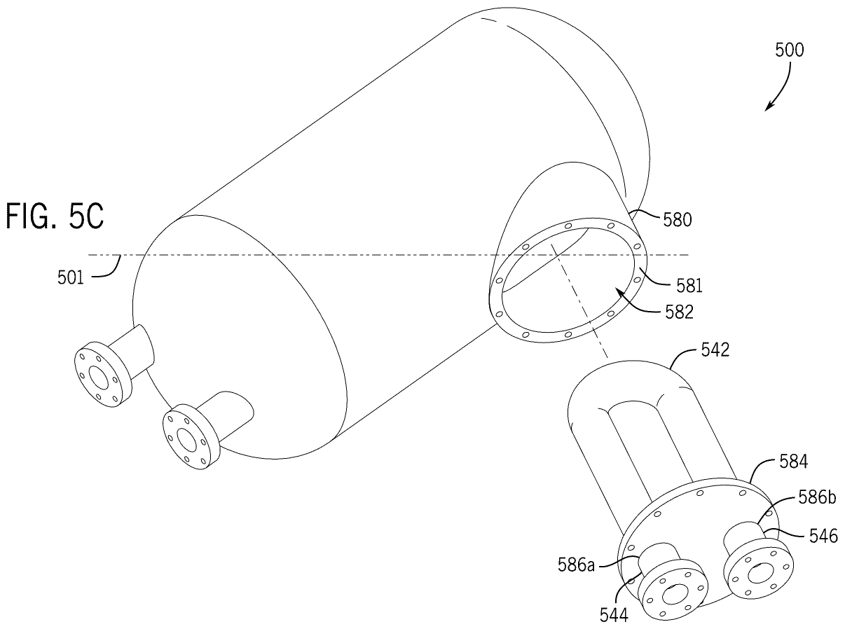

With reference to FIGS. 5A-5C, an example heat exchanger 500 is shown. The example heat exchanger 500 may be used in the molten salt system 100 as the primary heat exchanger 110, the secondary heat exchanger 162, and/or other heat exchanger of the system 100. The heat exchanger 500 is shown in FIG. 5B in cross-section, taken along line 5B-5B of FIG. 5A. The heat exchanger 500 is shown in FIG. 5C in an exploded view configuration showing select components removed from one another, as described herein. The heat exchanger 500 is shown relative to a horizontal axis 501. The horizontal axis 501 may be perpendicular to a gravitation direction of the heat exchanger 500. The heat exchanger 500 may therefore be configured to permit gravitational draining of fluid (e.g., molten salts therein) by arranging one or more inlet or outlets thereof offset or oblique from the horizontal axis 501. In this regard, the heat exchanger 500 may be substantially analogous to the heat exchanger 400, and may include: an outer shell 502, a cylindrical region 504a, end cap regions 504b, 504c, a shell inlet 506, an inlet passage 507, a shell outlet 508, an outlet passage 509, flanged connections 510a, 510b, a containment volume 519, a shell tube 520, a first surface 521a, a second surface 521b, a cold region 522, a volume 523, a heat transfer region 524, a hot region 526, an inner tube 542, a first surface 543a, a second surface 543b, a tube inlet 544, an inlet passage 545, a tube outlet 546, an outlet passage 547, flanged connections 548a, 548b, a tube volume 550, heat transfer region 552, fuel salt piping 590a, 590b, flanged connections 592a, 592b, coolant salt piping 596a, 596b, and flanged connections 598a, 598b; redundant explanation of which is omitted here for clarity.

Notwithstanding the foregoing similarities, the heat exchanger 500 may be configured to removably replace the inner tube 542. For example, the inner tube 542 may be a removably replaceable component of the heat exchanger 500 in order to support the maintenance, repair, and replacement of the heat exchanger 500 and tubes therein. In this regard, as shown in FIG. 5C, the inner tube 542 may be coupled with a cover 584. The cover 584 may be a flange or other structural feature through which the inner tube 542 may pass through and enter the containment volume 523. For example, the tube inlet 544 may pass through the cover 584 at an interface 586a. Further, the tube outlet 546 may pass through the cover 584 at an interface 586b. The inner tube 542 may be selectively positioned within the heat exchanger 500 by engagement of the cover 584 with a transition piece 580. The transition piece 580 may be an oblique pipe, fitting, and/or other component having an interface passage 582 that extends from an exterior of the heat exchanger 500 and into the containment volume 519. In operation, the inner tube 542 may be positioned at least partially within the containment volume 519 via the interface passage 582. In turn, the cover 584 may be removably secured to a face 581 of the transition piece 580, such as via bolts and/or other fasteners, in order to seal the inner tube 542 within the containment volume 519. In this regard, upon a shutdown event, the foregoing process may be reversed in order to remove the inner tube 542 from the containment volume 519 within necessarily disturbing the remainder of the heat exchanger 500. For example, the cover 584 may be uncoupled from the face 581, and the inner tube 542 removed from the containment volume 519 while the heat exchanger 500 remains in place with the molten salt system (e.g., the system 100).

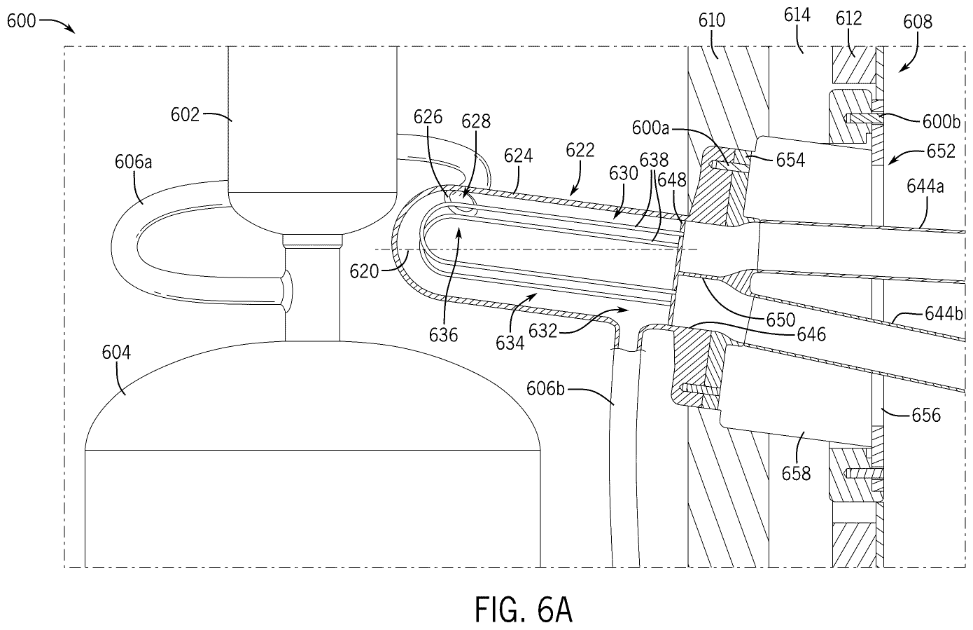

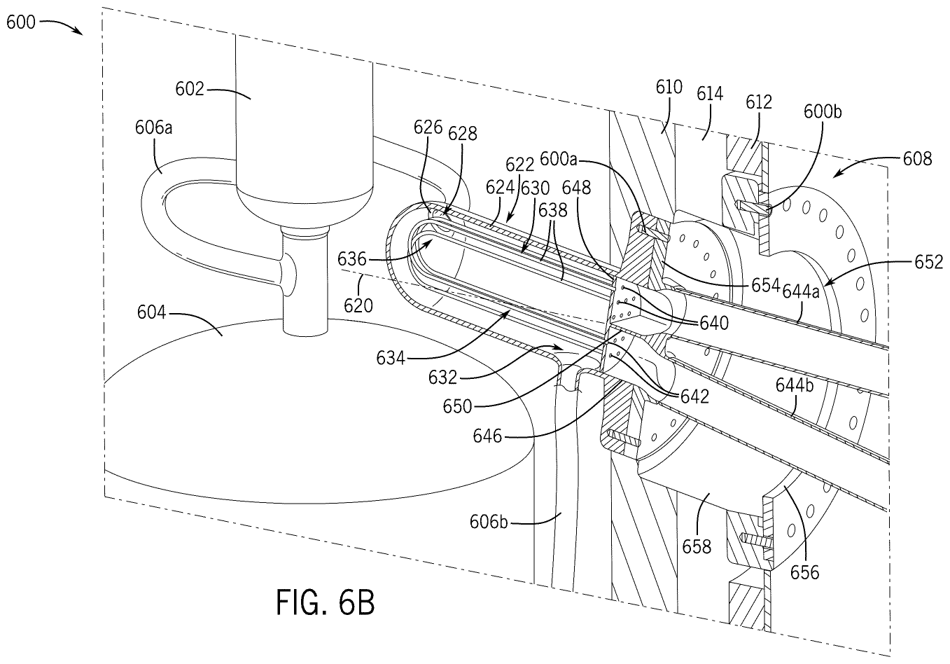

With reference to FIGS. 6A-6B, and example heat exchanger 612 installed into a molten salt reactor system 600 is shown. Molten salt reactor system 600 may be substantially similar to molten salt reactor system 100 of FIG. 1 and include a reactor vessel 604, a reactor access vessel 602, a primary heat exchanger 622, piping therebetween (606a, 606b), and a reactor enclosure 608 redundant explanation of which is excluded herein for clarity. Notwithstanding the foregoing similarities, reactor system 600 may include a double-layered reactor enclosure 608 including a thermal insulation layer 610 and a radiation shielding layer 612 and a gap 614 interposed therebetween.

Heat exchanger 622 may be used as the primary heat exchanger 110 of molten salt reactor system 100. The heat exchanger 622 is shown relative to horizontal axis 620. The horizontal axis 620 may be perpendicular to a gravitation direction of the heat exchanger 622. The heat exchanger 620 may therefore be configured to permit gravitational draining of fluid (e.g., molten salts therein) by arranging one or more inlet or outlets thereof offset or oblique from the horizontal axis 620. In this regard, the heat exchanger 622 may be substantially analogous to the aforementioned heat exchangers and include an outer shell 624, a shell inlet 626, an inlet passage 628, a shell volume 630, a cold region 632, a heat transfer region 634, a hot region 636, inner tubes 638, tube inlets 640, tube outlets 642, and coolant salt piping 644a, 644b redundant explanation of which is omitted here for clarity.

However, FIGS. 6A-6B highlight other components that may be included to install heat exchanger 622 into a reactor system. For example, heat exchanger 622 may further include a waterbox 646 configured to enable passage of a coolant into the plurality of tubes 638, a tube sheet 648 to hold the plurality of tubes 638, a partition 650 within waterbox 646 to separate incoming coolant from outcoming coolant.

Additionally, heat exchanger 622 may be mounted within the molten salt reactor system 600 and to the reactor enclosure 608 via a flange assembly 652. Flange assembly 652 may be operable to mount heat exchanger 622 into reactor system 600 such that it may facilitate heat transfer functions. Flange assembly 652 is further operable to facilitate removal of heat exchanger 622 for maintenance purposes, following gravitational draining as described herein. In this regard, flange assembly 652 may include a first flange 654 and a second flange 656. First flange 654 may be attached to thermal insulation layer 610 via bolt connections 660a while second flange 656 may be attached to radiation shielding layer 612 via bolt connections 600b. Interposed between first flange 654 and second flange 656 and facilitating a connection therebetween is penetrator 658. Penetrator 658 may generally extend from second flange 656, through gap 614, and to first flange 654. In this regard, flange assembly 652 enables access to first flange 654, such that it may be unbolted from thermal insulation layer 610 enabling removal of heat exchanger 622. Additionally, penetrator 658 enables such access while maintaining a continuous seal of reactor enclosure 608. In one example, heat exchanger 622 may be disconnected from piping 606a, 606b following gravitational draining. Then, flange 654 may be disconnected from thermal insulation layer 610 enabling an operator to pull heat exchanger 622 from reactor system 600. In another example, following gravitational draining and piping disconnection, flange 654 and flange 656 may be disconnected such that the entire flange assembly 652 may be removed along with heat exchanger 622.

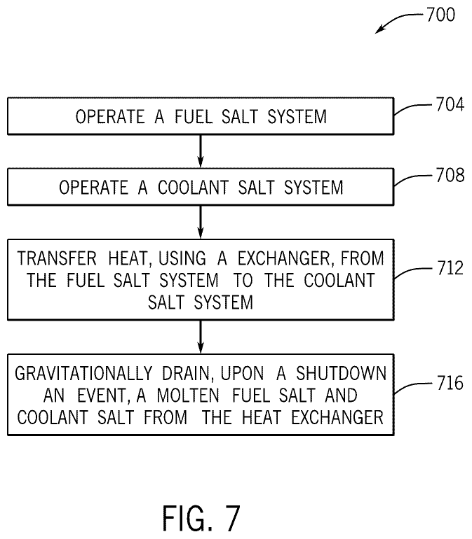

FIG. 7 depicts a flow diagram of a method 700 of draining a heat exchanger of a molten salt reactor system. At operation 704, a fuel salt system is operated. For example, and with reference to FIG. 1, the fuel salt system 101 of the molten salt system 100 is operated. As described herein, a molten fuel salt may undergo nuclear fission reactions within a reactor vessel 104 that causes the molten fuel salt to exhibit an elevated temperature. The elevated temperature molten fuel salt may circulate through the fuel salt system 101 to the heat exchanger 110 whereat heat may be removed from the molten fuel. The molten fuel salt may continue circulation through the fuel salt system 101 and into the reactor vessel 104 whereat the molten fuel salt may again be heated through nuclear fission reactions.

At operation 708, a coolant salt system is operated. For example, and with reference to FIG. 1, the coolant salt system 160 of the molten salt system 100 is operated. As described herein, a coolant salt (and/or other coolant medium) may be circulated through the heat exchanger 110 in order to remove heat from the molten fuel salt. For example, a coolant pump 172 may operate to induce a flow of a coolant to the heat exchanger 110 via coolant loop cold legs 166a, 166b. The coolant salt may receive heat from the heat exchanger 110, and may continue along the coolant salt system 160 to a secondary heat exchanger 162 via a coolant loop hot leg 164. The secondary heat exchanger 162 may operate to remove heat from the coolant salt for use in other processing, including electricity generation, chemical production and others. In this regard, FIG. 6 further shows an operation 712, in which heat is transfer from the fuel salt system 101 to the coolant salt system 160 using the heat exchanger 110.

At operation 716, the molten fuel salt and the coolant salt is gravitationally drained from the heat exchanger upon a shutdown event. For example, and with reference to FIGS. 1 and 2B, a fuel salt and/or a coolant salt may be gravitationally drained from the heat exchanger 200. For example, upon a shutdown event, fluid contained within the shell volume 220 may be encouraged to drain therefrom via the passages 207, 209, which are each offset from a horizontal direction of the heat exchanger 200. Further, upon a shutdown event, fluid contained within the tube volume 250 may be encouraged to drain therefrom via the passages 245, 247, which are each offset from a horizontal direction of the heat exchanger 200. Analogously, a fuel salt and/or a coolant salt may be gravitationally drained from any of the heat exchangers 300, 400, 500, 622. For example, upon a shutdown event, fluid contained within the respective volumes of the heat exchangers 300, 400, 500, 622 may be encouraged to drain therefrom via the respective passages, which are offset from a horizontal direction of the corresponding heat exchangers. By permitting the gravitational draining of the fluids (molten salts) from the heat exchangers, said molten salt may be inhibited from solidifying therein, and thus the heat exchangers may have a reduced amount of radioactive material therein upon such shutdown event. The reduced amount of radioactive material within the heat exchanger upon the shutdown event may support the maintenance, repair, and/or replacement of the heat exchanger and select components. Following gravitational draining the heat exchangers may be removed from the reactor system via, for example, flange assembly 652. Thereafter, the heat exchanger may undergo maintenance, repair and exchanged or may be simply replaced by a substantially similar heat exchanger.

Other examples and implementations are within the scope and spirit of the disclosure and appended claims. For example, features implementing functions may also be physically located at various positions, including being distributed such that portions of functions are implemented at different physical locations. The foregoing description, for purposes of explanation, uses specific nomenclature to provide a thorough understanding of the described examples. However, it will be apparent to one skilled in the art that the specific details are not required in order to practice the described examples. Thus, the foregoing descriptions of the specific examples described herein are presented for purposes of illustration and description. They are not targeted to be exhaustive or to limit the examples to the precise forms disclosed. It will be apparent to one of ordinary skill in the art that many modifications and variations are possible in view of the above teachings.

What is claimed is:

1. A molten salt reactor system comprising
a fuel salt system configured to circulate a molten fuel salt through a molten salt loop;
a coolant salt system configured to circulate a coolant salt through a coolant loop; and
a heat exchanger arranged along the molten salt loop and the coolant loop and configured to transfer heat from the molten fuel salt of the molten salt loop to the coolant salt of the coolant loop, wherein the heat exchanger is configured to permit gravitational draining of at least one of the molten fuel salt or the coolant salt upon a shutdown event.

2. The molten salt reactor system of claim 1, wherein the heat exchanger comprises
an outer shell defining a shell volume configured to receive one of the molten fuel salt or the coolant salt, and
an internal tube positioned at least partially within the shell volume and configured to receive the other of the molten fuel salt or the coolant salt.

3. The molten salt reactor system of claim 2, wherein
the outer shell comprises a baffle defining a shell circulation path about a portion of the internal tube positioned in the shell volume, and
the heat exchanger is arranged on the molten salt loop and the coolant loop with the circulation path positioned off-set from a horizontal direction of the molten salt reactor system.

4. The molten salt reactor system of claim 3, wherein the internal tube extends oblique to the outer shell within the shell volume.

5. The molten salt reactor system of claim 4, wherein
the internal tube comprises a plurality of bends within the internal tube volume, and
the oblique orientation of the internal tube relative to the outer shell permits draining of the other of the molten fuel salt or the coolant salt upon the shutdown event.

6. The molten salt reactor system of claim 2, wherein the internal tube extends substantially along the shell circulation path.

7. The molten salt reactor system of claim 1, wherein
the shell circulation path proceeds along a U-shaped path through the shell volume,
the internal tube comprises a U-shaped tube extending along the U-shaped path, and
an inlet and an outlet for the shell circulation path and an inlet and outlet for the internal tube are each arranged along a bottom side of the outer shell such that the respective inlets and outlets are each substantially aligned with a vertical direction of the molten salt reactor system.

8. The molten salt reactor system of claim 1, wherein the shutdown event is triggered based on one or more of a loss of power, a high radiation alarm and/or a containment breach.

9. The molten salt reactor system of claim 1, wherein
the molten salt reactor system further comprises a reactor vessel, a pump, and a drain tank all arranged along the molten salt loop, and
the reactor vessel outputs an elevated temperature form of the molten fuel salt to the heat exchanger.

10. The molten salt reactor system of claim 1, wherein
the heat exchanger comprises a pair of oblique tubes associated with one another inside of an outer shell,
a first oblique tube of the pair of oblique tubes is configured to receive one of the molten fuel salt or the coolant salt, and
a second oblique tube of the pair of oblique tubes is configured to receive the other of the molten fuel salt or the coolant salt.

11. The molten salt reactor system of claim 10, wherein the first oblique tube is removably couplable from the outer shell and separatable from the first oblique tube.

12. The molten salt reactor system of claim 1, further comprising a flange assembly operable to facilitate removal of the heat exchanger from the molten salt reactor system.

13. A molten salt reactor system comprising
a fuel salt system configured to circulate a molten fuel salt through a molten salt loop;
a coolant salt system configured to circulate a coolant salt through a coolant loop; and
a heat exchanger arranged along the molten salt loop and the coolant loop and configured to transfer heat from the molten fuel salt of the molten salt loop to the coolant salt of the coolant loop, wherein the heat exchanger comprises at least one oblique tube configured to route at least one of the molten fuel salt or the coolant salt out of the heat exchanger upon a shutdown event.

14. The molten salt reactor system of claim 13, wherein
the heat exchanger comprises a shell and tube heat exchanger, and
the at least one oblique tube is arranged oblique to an outer shell of the shell and tube heat exchanger.

15. The molten salt reactor system of claim 13, wherein the molten fuel salt and the coolant salt begin to solidify at a solidification temperature that is below 550° C.

16. The molten salt reactor system of claim 13, wherein
the at least one oblique tube comprises
a first oblique tube configured to route the molten fuel salt out of the heat exchanger, and
a second oblique tube configured to route the coolant salt out of the heat exchanger.

17. The molten salt reactor system of claim 16, wherein a portion of the first oblique tube and a corresponding portion of the second oblique tube are removably interposed with one another with an outer shell of the heat exchanger.

18. The molten salt reactor system of claim 13, further comprising a flange assembly operable to facilitate removal of the heat exchanger from the molten salt reactor system.

19. A method of draining a heat exchanger of a molten salt reactor system, the method comprising
operating a fuel salt system by circulating a molten fuel salt through a molten salt loop;
operating a coolant salt system by circulating a coolant salt through a coolant salt loop;
transferring heat, using a heat exchanger, from the molten fuel salt of the molten salt loop to the coolant salt of the coolant salt loop; and
gravitationally draining, upon a shutdown event, the molten fuel salt and the coolant salt from the heat exchanger.

20. The method of claim 19, wherein the heat exchanger comprises at least one oblique tube configured to route at least one of the molten fuel salt or the coolant salt through the heat exchanger during the transferring.

21. The method of claim 20, wherein said at least oblique tube is arranged oblique to an outer shell of the heat exchanger.

22. The method of claim 19, wherein the molten fuel salt includes a fissile material.
